(19) United States
(12) Patent Application Publication
(10) Pub. No.: US 2016/0357435 A1
(43) Pub. Date: Dec. 8, 2016

(54) HIGH DENSITY HIGH THROUGHPUT LOW POWER CONSUMPTION DATA STORAGE SYSTEM WITH DYNAMIC PROVISIONING

(71) Applicant: Alibaba Group Holding Limited, George Town (KY)

(72) Inventors: Shu LI, Santa Clara, CA (US); Gongbiao NIU, Hangzzhou (CN)

(21) Appl. No.: 14/733,605

(22) Filed: Jun. 8, 2015

(51) Int. Cl. G06F 3/06

(52) U.S. Cl. CPC G06F 3/061; G06F 3/065; G06F 3/067; G06F 3/0665; G06F 3/0688; G06F 3/0659

(57) ABSTRACT

A data storage apparatus includes a node controller, a plurality of storage unit coupled to the node controller and having a plurality of storage modules. The plurality of storage modules, coupled to the storage units for storing data, are mounted on at least one side of a printed circuit board of the storage modules and are in communication with the node controller via a data interface layer. The data storage apparatus further includes a backplane having a plurality of slots, via which the storage modules are connected to the backplane. The node controller is configured to present to a data client a single storage image of stored data, and in response to data commands by the data client, reads and writes data from the plurality of storage devices over the data interface layer.

### TECHNICAL FIELD

The present invention relates generally to data storage systems, and more particularly to data storage systems providing high capacity and high throughput yet with low power consumption and dynamic data storage provisioning.

### BACKGROUND

Data centers constantly are faced with the problem of how to design data storage systems that meet the fast growing data storage appetites of applications serviced in a timely, efficient and effective manner. Optimized system performance in forms of capacity and throughput, reduced system cost (i.e., CAPEX and OPEX), flexible system expandability and re-configurability are highly valued and sought after features in regard to a data storage system, especially in the up and coming era of big data.

For example, when the growth of the requirement of data space out-paces that of the computational power at a high rate, a data center is challenged in terms of how to increase its data storage space without, or with minimal amount of, upgrading or re-configuring its existing servers, which leads to associated costs and down time.

One solution towards the problem described above is to have differentiated server nodes: one type specialized for computation and the other data storage and access. This way, the computational capacity of a data center can be configured and upgraded independently from the capacity of data access and storage. Typically, such a data center allocates the computational and data storage resources at the launch time of the application programs it services. However, the demand for data space from an application program is not likely to stay static over the life time of the application program. For the data center to predict such changing provisioning of an application program during its life time, which can span over years, is difficult.

### SUMMARY

According to one exemplary embodiment of the present disclosure, a data storage system for providing high capacity and high throughput with low power consumption and dynamic provisioning includes a node controller, a plurality of storage units coupled to the node controller and having a plurality of storage modules. The plurality of storage modules include a plurality of storage devices for storing data. The plurality of storage devices are mounted on at least one side of a printed circuit board of the storage modules and the plurality of storage devices are in communication with the node controller via a data interface layer. The data storage system further includes a backplane having a plurality of slots, via which the storage modules are connected to the backplane. The node controller is configured to present to a data client a single storage image of stored data, and in response to data commands by the data client, reads and writes data from the plurality of storage devices over the data interface layer.

According to another exemplary embodiment of the present disclosure, a storage device for providing a data system having high capacity and high throughput with low power consumption and dynamic provisioning includes a plurality of non-volatile memory chips, and a memory controller configured to send and receive data to and from the memory chips. The plurality of memory chips and the controller are integrated in a single chip, which is mounted onto at least one side of a module board. The data storage device sends and receives the data traffic over a data interface layer external to the storage device.

According to yet another exemplary embodiment of the present disclosure, a data storage node controller includes a network interface device through which to communicate with a data client, a storage interface device through which to communicate with a plurality of storage devices, a processor coupled to the network interface device and the storage interface device to control operation of the data storage node controller, and a storage medium coupled to the processor and having embedded therein program instructions which configures the processor to cause the storage node controller to execute a process of presenting to the data client a single system image of data stored in the plurality of storage devices.

According to still another exemplary embodiment of the present disclosure, a method for providing dynamic data allocation includes operating a data storage with at least one storage node comprising a node controller and a plurality of storage devices in communication with the node controller via a SAS expander interface. The data storage presents to a data client a single storage image for storing data, and the single storage image comprises a plurality of storage segments with reference addresses. The method further includes receiving a first data request of a first size, allocating a first space from the single storage image at a reference address of available storage segment, and updating the reference address of the available storage segment to reflect the allocation of the first space. The method also includes receiving a second data request of a second size, allocating a second space from the single storage image at a updated reference address of available storage segment, and updating the reference address of available storage segment to reflect the allocation of the second space. The method further includes monitoring unused space in the first space and using a pre-determined consolidation policy to determine whether a portion of the first space is to be freed. If a portion of the unused first space is to be freed, the method further includes the steps of re-allocating the second space to remove a unused portion of the first space, and updating the reference address of available storage segment to reflect the re-allocation of the second space.

The details of one or more embodiments of the disclosure are set forth in the accompanying drawings and the description below. Other features, objects, and advantages of the disclosure will be apparent from the description and drawings, and from the claims.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a schematic view of a system utilizing an exemplary data storage system in accordance with an embodiment of the present disclosure;

FIGS. 2A-2C are perspective views of an exemplary data storage node, an exemplary data storage unit, and an exemplary data storage module of the data storage system of FIG. 1, in accordance with an embodiment of the present disclosure;

FIG. 3 is a schematic diagram of an exemplary backplane of the data storage node of FIG. 2A in accordance with an embodiment of the present disclosure;

FIG. 4 is a block diagram of an exemplary data storage module of the data storage unit of FIG. 2B in accordance with an embodiment of the present disclosure;

FIG. 5 is a schematic block diagram of an exemplary data storage device of the data storage module of FIG. 4 in accordance with an embodiment of the present disclosure;

FIG. 6 is schematic diagram of an exemplary interface expansion layer that communicatively couples the plurality of data storage devices to the node controller in accordance with an embodiment of the present disclosure;

FIG. 7 is a block diagram of an exemplary node controller in accordance with an embodiment of the present disclosure;

FIG. 8 is a schematic diagram of a storage pool that shows a method of dynamic data storage allocation in accordance with an embodiment of the present disclosure; and

FIG. 9 is a flow chart representing an exemplary method of dynamic data storage provisioning by the node controller in accordance with an embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the disclosure do not inherently indicate any particular order nor imply any limitations in the disclosure.

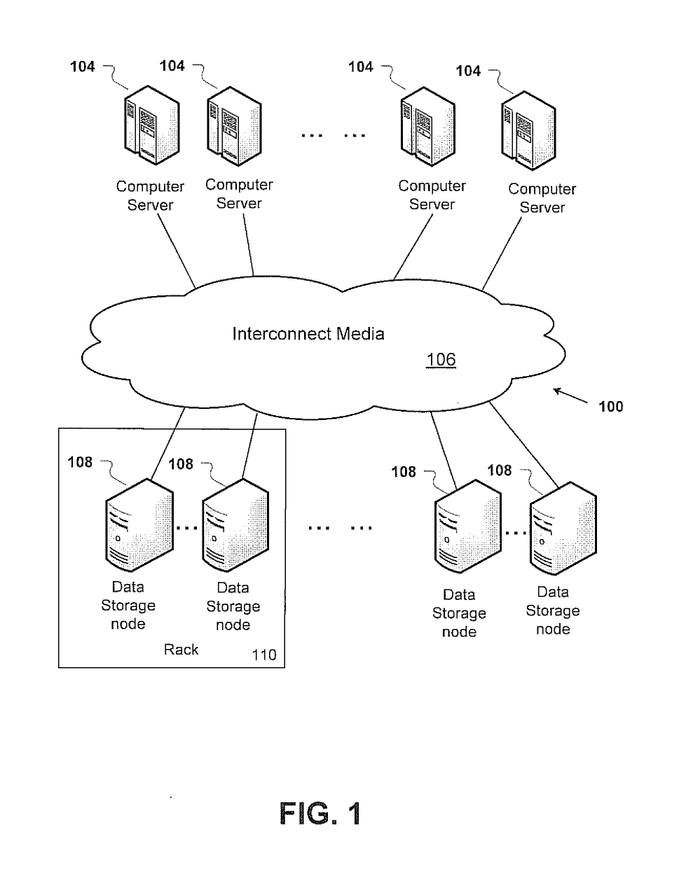

Embodiments of the present disclosure are discussed herein with reference to FIGS. 1-9. However, those skilled in the art will readily appreciate that the detailed description given herein with respect to these figures is for explanatory purposes as the disclosure extends beyond these limited embodiments.

Referring to FIG. 1, a data system is shown to include a number of data storage clients such as computational nodes 104, a data storage system 100 and interconnect media 106 connecting the computational nodes 104 and the data storage system 100. The data storage system 100 includes a plurality of data storage server nodes 108, which can further form a data storage rack 110 of storage nodes. Such a data storage rack 110 can include one or any number of data storage server nodes 108. The interconnect media 106 communicatively couples the computational nodes 104 and the data storage server nodes 108. For example, one computational node 104 can be configured to communicate with some or all of the data storage server nodes 108 through the interconnect media 106. In some embodiments, the interconnect media 106 can be implemented utilizing fiber channels or the like, to supply high speed interconnect for the nodes connected therebetween.

Alternatively, the data storage nodes 108 can be configured to be in communication with each other via a switching fabric (not shown), for example, a Gigabyte Ethernet switch. The data storage server nodes 108 are operated and managed collectively to present to users or data clients such as the computation nodes 104 of the data storage system 100 a single system image of all data stored therein.

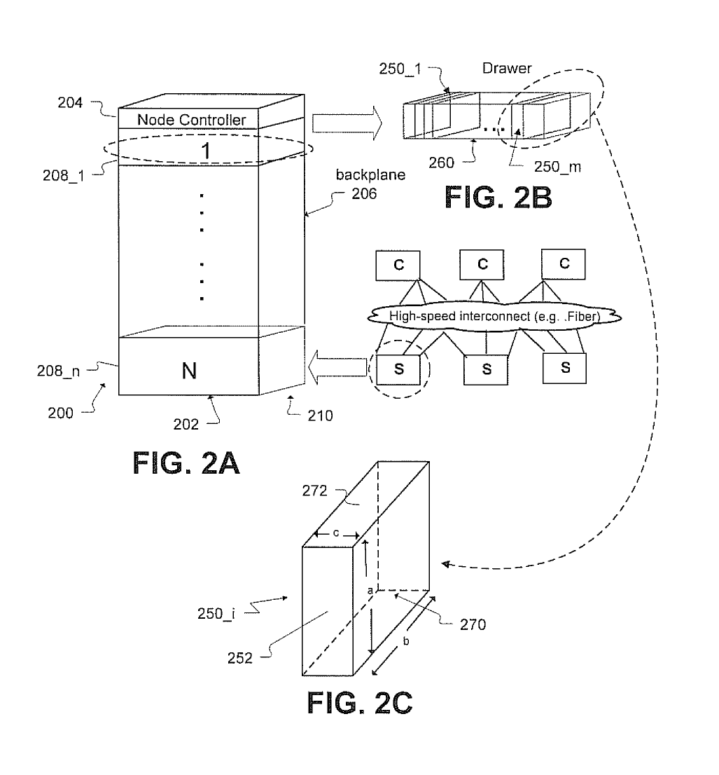

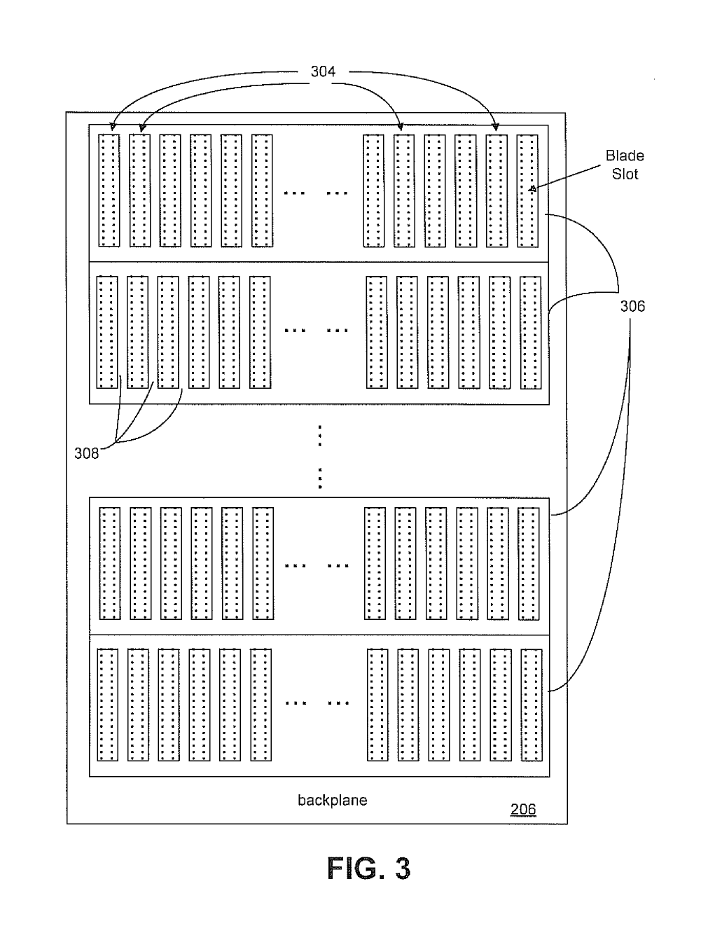

Referring to FIG. 2A, a perspective view of an exemplary data storage rack of FIG. 1 is shown to have a single data storage server node 200 in accordance with an embodiment of the present disclosure. The data storage server node 200 includes a rack 202, a storage node controller 204, a number of data storage units 208_1, 208_2, . . . , 208_n, where n is a natural number greater than 1. The rack 202 includes a number of accommodating spaces, in which the storage node controller 204 and storage units 208_1 to 208_n are respectively placed. The rack 202 further includes a backplane 206 (as shown in FIG. 3) disposed at a backside 210 of the rack 202 for connecting the storage units 208_1 to 208_n to the storage node controller 204.

As shown in FIG. 2B, each of the data storage units 208_1 to 208_n includes a structure 260 and a plurality of data storage modules 250_1, 250_2, . . . , 250_m, where m is a natural number greater than 1. The structure 260 holds together the plurality of data storage modules 250_1 to 250_m, forming a block which can be stacked to fill the accommodating spaces of the rack 202. In some embodiments, the structure 260 can be implemented in a rectangular block shape to provide enclosing support only along the 12 edges of the block, providing accommodating spaces in which the data storage modules 250_1 to 250_m are placed. Each of the data storage modules 250_1 to 250_m is disposed in the spaces of the structure 260 in an orientation such that, when connected via the slots (as shown in FIG. 3) onto the backplane of the rack 202, the structure 260 can house as many storage modules as possible for the purpose of enhancing the data storage density provided with the amount of accommodating spaces of the structure 260.

Referring to FIG. 2C, a perspective view of a data storage module 250_i of the plurality the data storage modules 250_1 to 250_m is shown in accordance with an embodiment of the present disclosure. In some embodiments, the data storage module 250_i has a right surface 270 and a right surface 272, a width a, a length b and a thickness c. Two sides of storage module 250_i along the width a direction and two sides of the storage module 250_i along the thickness c direction forms a back surface 252. The storage module 250_i is placed in the structure 260 with the back surface 252 disposed towards the backplane 206 of the rack 202. In other words, the storage module 250_i is disposed with its right surface 270 and left surface 272 perpendicular to the backplane 206. As a result, the storage module 250_i connects to the respective slot (as shown in FIG. 3) configured on the backplane 206 at the back surface 252. Consequently, the backplane 206 can be configured to accommodate an enhanced number of slots and therefore an enhanced corresponding number of storage module 250_1 to 250_m, which in turn provides for enhanced data storage density.

Referring to FIG. 3, a schematic diagram illustrating the backplane 206 of the rack 202 of FIG. 2 is shown to include a plurality of slots 304_1, 304_2, . . . , 304_m, where m is a natural number greater than 1. The number of the slots 304_1 to 304_m matches to the number of storage modules 250_1 to 250_m such that each storage module 250_i of the storage modules 250_1 to 250_m is configured to connect to its respective slot 304_i in a one to one relationship. Via the plurality of slots 304_1 to 304_m, the plurality of storage modules 205_1 to 250_m is communicatively coupled to the node controller 204 of the storage node 200.

As shown in FIG. 3, in some embodiments, the slots 304_i can be configured to be disposed vertically at the backplane 206 in parallel to each other and forming a plurality of rows 306, each of the rows 306 corresponds to a respective data storage unit 208. The plurality of slots 304_1 to 304_m also forms a corresponding vertical air channels 308 throughout the rack 202, serving the purposes of improved heat dissipation for the data storage devices mounted on the data storage modules. In some embodiments, the node controller 204 can be connected to the backplane 202 via Peripheral Component Interconnect Express (PCI-e) connector.

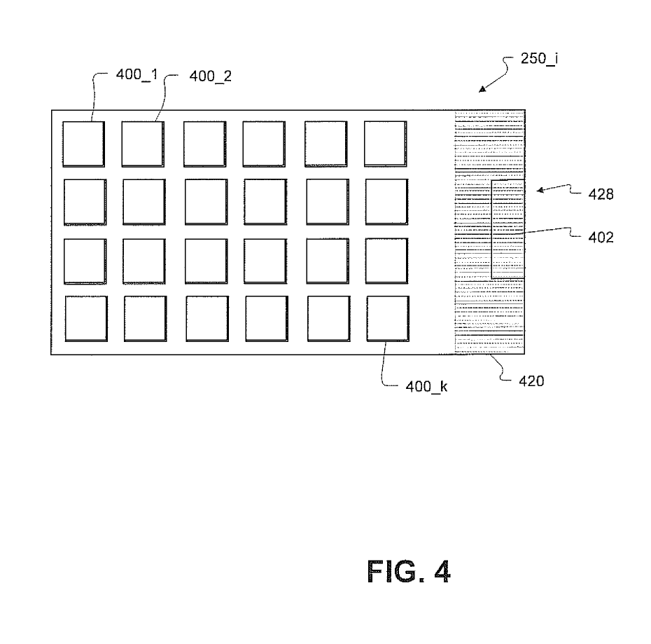

Referring to FIG. 4, a schematic block diagram of the storage module 250_i of the plurality of the storage module 250_1 to 250_m, where i is a natural number between 1 and m, is illustrated in accordance with an embodiments of the present disclosure. The storage module 250_i is shown to include a printed circuit board 420 mounted on the right side 270 of the storage module 250_i in an orientation that a back end 428 of the printed circuit board 420 is disposed towards the back side 252 of the storage module 250_i. The circuit board 420 has a plurality of storage devices 400_1, 400_2, . . . , 400_k, where k is a natural number greater than 1. The plurality of the storage devices 400_1 to 400_k are mounted on at least one side of the printed circuit board 420. The storage module 250_i further includes an interface 402 disposed toward the back side 252 of the storage module 250_i such that, with the storage module 250_i plugged onto its respective slot 304_i at the backplane 202, the interface 402 is in connection with the backplane 202, and therefore in communication with the node controller 204. In some embodiments, the plurality of storage devices 400_1 to 400_k can be mounted onto the printed circuit board 420 using soldering techniques. In alternative embodiments, the printed circuit board 420 and the same storage module 250_i can be implemented as one board.

With Solid State Device (SSD) employed as data storage devices in replace of conventional hard disks, the data system provides for the advantages in terms of performance, size, weight, ruggedness, operating temperature range, and power consumption. The number of the plurality of the storage devices 400_i can be configured to provide a target capacity, throughput, redundancy and/or power consumption requirement for a storage node, taking into account of the design of the number of the storage modules, the number of the respective storage units that can be housed in the storage node. Furthermore, the redundancy provided by the plurality of storage devices can be configured for providing data recovery, system maintenance or the like without system down-time, i.e., with the storage system staying on-line and accessible to all the application programs serviced.

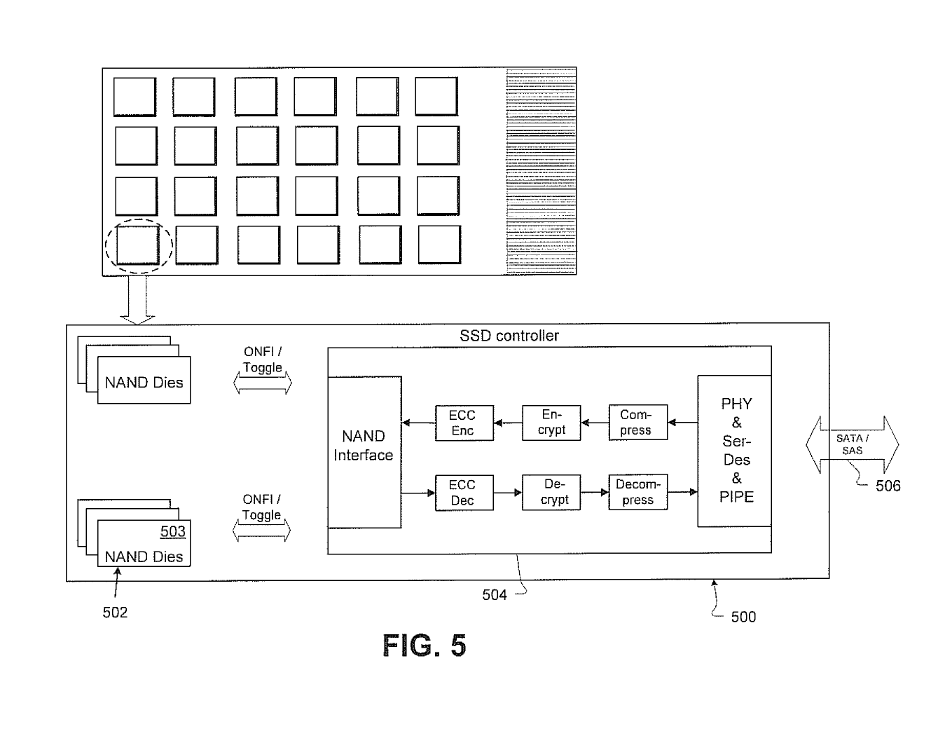

Referring to FIG. 5, a schematic block diagram of a storage device of FIG. 4 is shown in accordance with an embodiment of the present disclosure. The storage device 500 includes a plurality of memory chips 502, a controller 504 and an interface connector 506. The memory chips 502 can be, for example, non-volatile memory devices such as NAND flash memory chips, each of the memory chips 502 further including one or more memory dies 503 (as shown in FIG. 3 three NAND dies). The memory chips 502 are configured to store data for the storage device 500, and are communicatively coupled to the controller 504 for data access through at least one interface component such as a NAND interface.

The storage device 500 is configured to store and retrieve data in response to data commands received via an interface connector 506. In some embodiments, the controller 504 may be configured as a flash controller (SSD controller) for each of the memory chips 502 of the storage device 500. For example, the controller 504 can be configured to include circuit components such as a NAND interface, EEC decoder, descriptor, de-compressor and a physical/serializer-deserializer/PIPE interface, in that order, forming a communication path from the memory chips 502 to the interface connector 506. On the reverse communication path from the interface connector 506 to the memory chips 502, the SSD controller 504 can be configured to include the physical/serializer-deserializer/PIPE interface, compressor, encryptor, ECC encoder and the NAND interface. The NAND interface communicates with the NAND memory chips on the ONFI toggle protocol; while the physica/serial/PIPE interface is in communication with the interface connector 506.

In some embodiments, the controller 504 and the plurality of the memory chips 502 can be integrated in the form of a single storage device chip, utilizing, for example, MCP (multiple chip package) technology or other technologies known to one with the ordinary skills of the art. In this case, the connection pins of the single storage device chip formed by the controller 504 and the plurality of the memory chips 502 can be configured to be coupled to and in communication with the printed circuit board 420.

The interface connector 506 is configured to provide two-way communication between the storage device 500 and the node controller 204 of the data storage node 200. The interface 506 is configured to communicate according to bus protocols such as, for example, Serial Advanced Technology Attachment (SATA) and Serial Attached SCSI (SAS). The storage device 500 can be constructed of any physical dimensions such that it meets the requirement of the density design configured for each of the storage modules, the storage units and consequently the storage node.

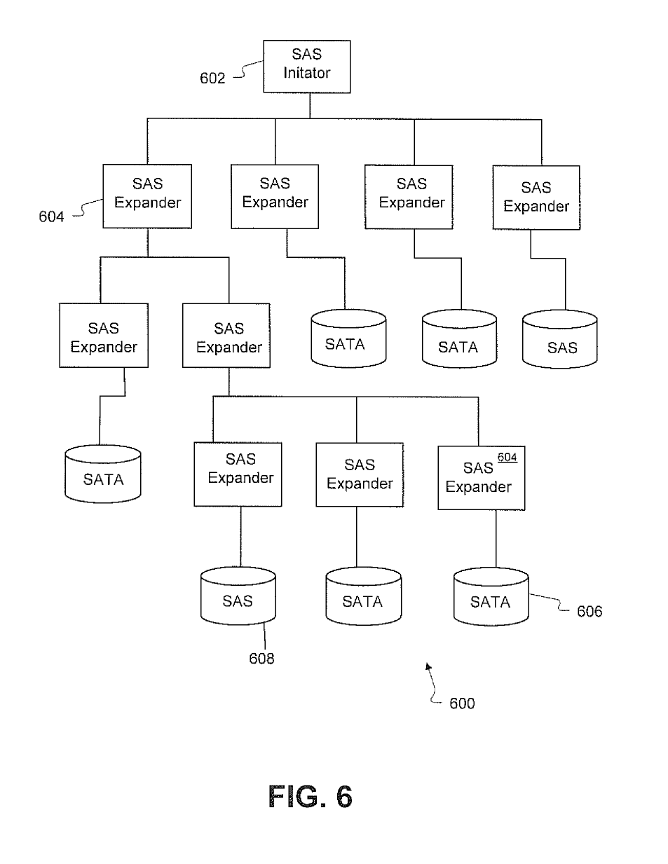

Referring to FIG. 6, a schematic diagram of an exemplary interface layer 600 of the data storage node 200 of FIG. 2 is shown to employ a SAS/SATA signaling protocol with an interface hierarchy to connect at least one initiator and at least one storage device, in accordance with an embodiment of the present disclosure. In some embodiments, at the leaf level, each individual storage device 500 of FIG. 5 can be coupled via the interface connector 506 of the storage device 500 to as either a SAS device 608 or as a SATA device 606, depending on the bus protocol the connector 506 is configured to communicate with. At the intermediary levels between the devices and a SAS initiator 602, a plurality of intermediary expanding components such as SAS expanders 604 are configured to connect to the SAS device 608 or the SATA device 606 at one side, and another SAS expander 604 at the other side, or to the SAS initiator 602 at the other side if the SAS expanders 604 are configured at the immediate next level to the root of the interface layer 600. In some embodiments, the SAS initiator 602 can be implemented at the storage node controller 204 of FIG. 2 so as to transmit and receive data traffic to and from the plurality of storage devices 500 connected thereto via the interface layer 600.

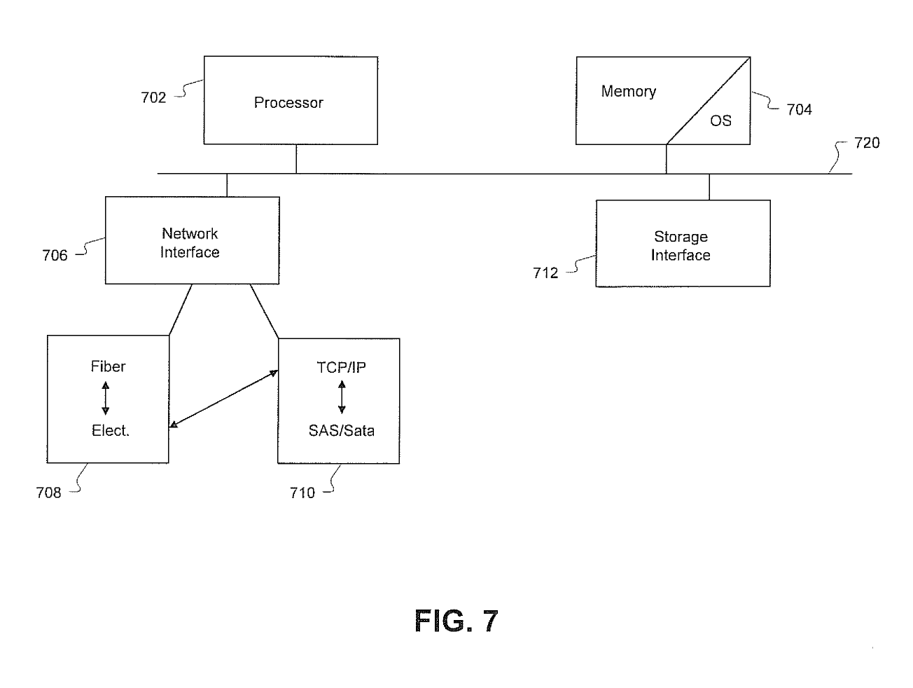

Referring to FIG. 7, a schematic block diagram of the node controller 204 of FIG. 2 is shown in accordance with an exemplary embodiment of the present disclosure. The node controller 700 includes a processor 702, a memory 704 hosting an operating system and/or programs executed on the node controller 700, a network interface 706 and a storage interface 712, all connected by an interconnect 720. The network 706 further includes an interface adaptor 708 converting fiber signals to and from electrical signals, as well as an interface adaptor 710 converting TCP/IP commands to and from SAS/SATA commands. In some embodiments, the storage interface 712 is configured for hosting the SAS initiator functionality for the purpose of transmitting and receiving data traffic to and from the plurality of storage devices connected via the interface layer 600. In alternative embodiments, the node controller 700 can further include a node interface through which the node controller 700 communicates with at least another node controller in a cluster of storage nodes to collectively and cooperatively present to the data client the single system image of data. Although they are described as independent functional blocks, two or more or all of the functional blocks can be integrated into one component in practice.

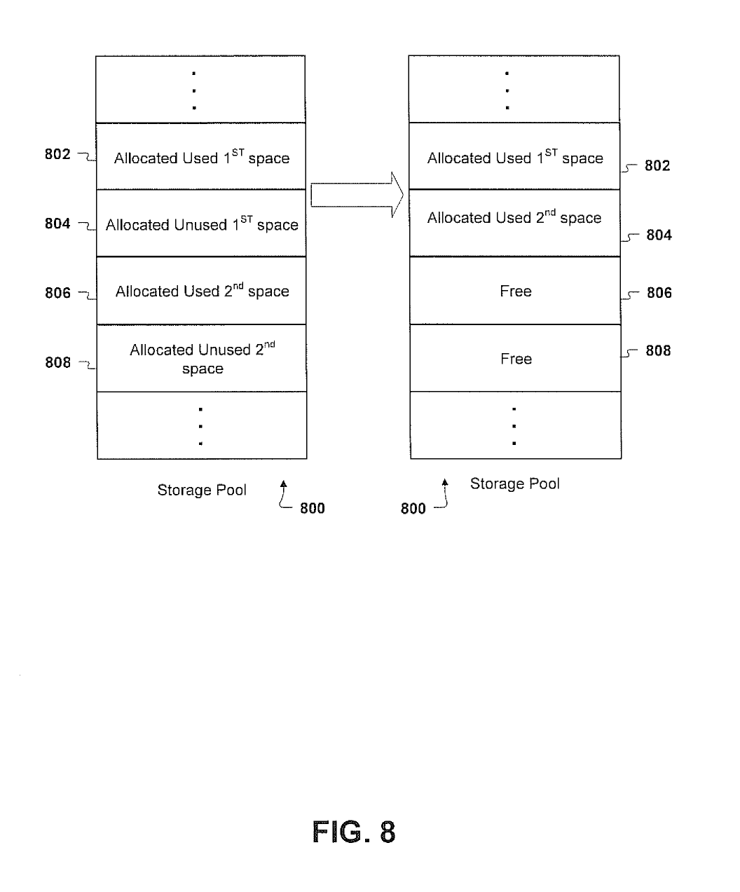

Referring to FIG. 8, a simplified exemplary storage image pool is shown to implement a method of dynamic data storage provisioning in accordance with an embodiment of the present disclosure. As the plurality of the storage devices 208_1 to 208_n are managed by the node controller 204 to present to a single storage image pool 800, the node controller 204 is configured to assign and allocate storage spaces of requested sizes from the storage pool 800 for each application program serviced by the data storage system 100. For example, the node controller 204 first allocates a first space upon the launch of a first application program serviced, starting from a storage segment previously marked as next immediately available. The allocated first space includes an allocated used first space 802 and an allocated unused first space 804 for the first application program. Subsequently, upon the launch of a second application program serviced by the data storage system, the node controller 204, starting from the available storage segment immediate next to the allocated unused first space 804, allocates a second space of a requested size out of the storage pool 800 to the second application program. Again, the second space includes an allocated used second space 806 and an allocated unused second space 808.

During the period of time with both of the application programs executing, the node controller 204 observes and monitors the usage of the allocated unused first space 804 and the allocated unused second space 808. The node controller 204 consults a pre-determined policy to determine whether the allocated unused first space 804 and the allocated unused second space 808 can be freed up and returned to the storage pool 800 due to the lack of usage by its respective application programs. For example, the pre-determined policy can specify a certain period of time after which no usage of an allocated space triggers returning of the allocated space to the storage pool. In some embodiments, such certain period of time can be implemented as a fixed threshold universal for the entire storage pool. In other embodiments, such certain period of time can be implemented as different amount of time tailored to different data storage demands and behaviors of different application programs. As shown in FIG. 8, in observing that none of the first or the second application has utilized its respective allocated unused space 804 and 808 for a period of time, and in determining that the observed period of time exceeds the pre-defined threshold period of time based on the pre-determined policy, the node controller 204 re-allocates space 804 for the second application program and de-allocates spaces 806 and 808, returning spaces 806 and 808 corresponding storage segments to the storage pool 800 as free. The node controller 204 also adjusts the next immediately available storage segment as starting at the beginning of space 806.

In some embodiments, the node controller 204 can be configured to observer or monitor the unused yet allocated space at a pre-determined manner. For example, such monitoring can be configured every certain period of time, or it can be performed upon triggering events such as less frequent data demand from a certain application program serviced.

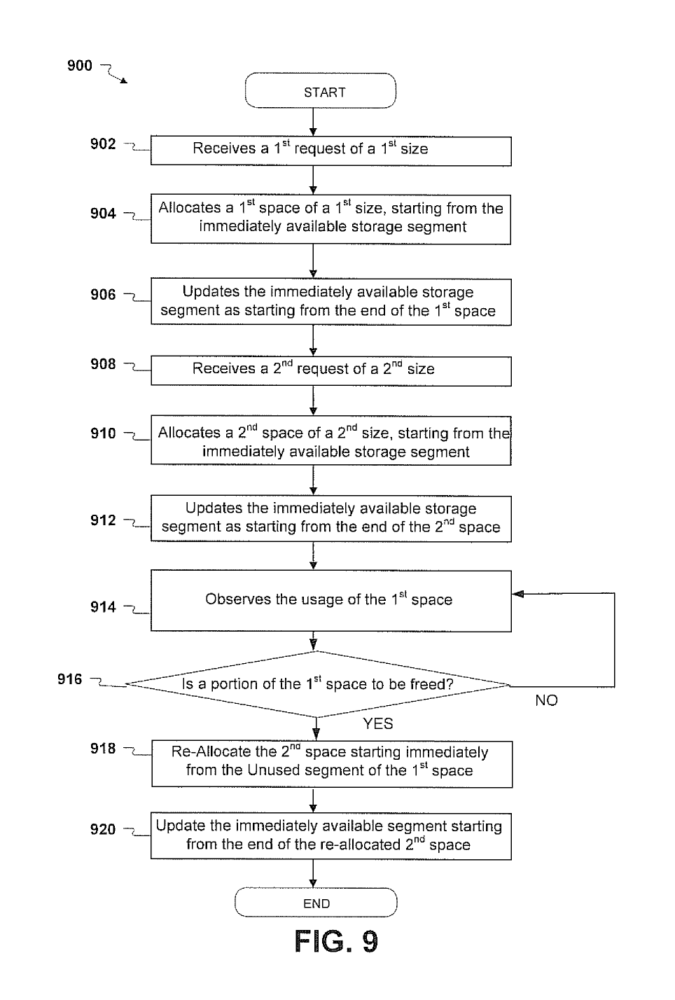

Referring to FIG. 9, a flow chart illustrating an exemplary method of dynamic storage allocation by the node controller of the data storage system is shown in accordance with an embodiment of the present disclosure. The method 900 starts at block 902, where a first request of a first size from a first application program is received by the node controller. In response, in block 904, the node controller allocates a first space of the first size to the first application from the storage pool, and in block 906, marks an immediately available storage segment starting at the immediate segment next to the end of the first space allocated to the first application. Subsequently, in block 908, the node controller receives a second request for second size from a second application program. In response, in block 910, the node controller allocates a second space of a second size, starting from the marked immediately available storage segment; in block 912, the node controller marks a new immediately available storage segment starting at the immediate segment next to the end of the second space allocated to the first application.

In block 914, the node controller observes that all or some portions of the first space allocated to the first application program has not been utilized for a period of time. In decision block 916, along the YES path, the node controller calculates that the observed period of time exceeds a pre-determined threshold amount of time, and consequently determines that the allocated unused space can be freed and proceeds to block 918. In block 918, the node controller re-allocates the second space for the second application program starting at a storage segment immediately next to the storage segment allocated and used by the first application program. In decision block 916, along the NO path, the node controller calculates that the observed period of time does not exceed a pre-determined threshold amount of time, and consequently goes back to block 914 and continues to observe. In block 920, the node controller further updates the reference to the available storage segment accordingly to reflect the re-allocation of the second space for the second application program.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A data storage apparatus comprising:
a node controller;
a plurality of storage units coupled to the node controller and having a plurality of storage modules;
a plurality of storage devices coupled to the plurality of storage units for storing data, wherein the plurality of storage devices are mounted on at least one side of a printed circuit board of the storage modules, wherein the plurality of storage devices are in communication with the node controller via a data interface layer; and
a backplane having a plurality of slots, via which the storage modules are connected to the backplane, wherein the node controller is configured to present to a data client a single storage image of stored data, and in response to data commands by the data client, reads and writes data from the plurality of storage devices over the data interface layer.

2. The data storage of claim 1, wherein the data interface layer is configured to communicate with SAS/SATA protocol.

3. The data storage of claim 1, wherein the node controller configures the plurality of storage devices to store one or more additional copy of data stored in the data storage.

4. The data storage of claim 1, wherein the node controller is configured to dynamically allocate data storage by monitoring unused space allocated to a first application to determine whether a portion of the unused space is to be freed based on a pre-determined policy, and if a portion of the unused space is to be freed, consolidating a portion of the unused space with a space allocated to a second application.

5. The data storage of claim 1, wherein the storage device comprises:
an interface device;
a memory controller connected to the interface device; and
a plurality of non-volatile memory chips controlled by the memory controller, wherein the interface device communicatively couples the storage device to the data interface layer of the data storage.

6. The data storage of claim 5, wherein the plurality of the memory chips are flash memory chips.

7. The data storage of claim 5, wherein the memory controller is a solid state drive (SSD) controller.

8. The data storage of claim 5, wherein the memory controller and the memory chips are integrated in a single chip.

9. The data storage of claim 2, wherein the interface layer comprises:
a SAS initiator; and
a first plurality of SAS expanders connected to the SAS initiator,
wherein the SAS expanders are configured to connect to a second plurality of SAS expanders or a SAS/SATA storage device, wherein the second plurality of SAS expanders are configured to connect to another SAS expander or a SAS/SATA storage device, wherein the SAS/SATA storage device corresponds to one of the plurality of storage devices, wherein the SAS initiator is configured to read and write data from the plurality of storage devices.

10. The data storage of claim 9, wherein the SAS initiator is implemented at the node controller.

11. A data storage node controller comprising:
a network interface device through which to communicate with a data client;
a storage interface device through which to communicate with a plurality of storage devices;
a processor coupled to the network interface device and the storage interface device to control operation of the data storage node controller; and
a storage medium coupled to the processor and having embedded therein program instructions which configures the processor to cause the storage node controller to execute a process of presenting to the data client a single system image of data stored in the plurality of storage devices.

12. The data storage node controller of claim 11, further comprising a node interface through which the controller communicates with at least another node controller in a cluster of storage nodes to collectively and cooperatively present to the data client the single system image of data.

13. The data storage node controller of claim 11, wherein the process further comprises converting TCP/IP protocol to and from SAS/SATA protocol.

14. The data storage node controller of claim 11, wherein the process further comprises converting electronic signals to and from fiber channel signals.

15. The data storage node controller of claim 11, wherein the process further comprises configuring the plurality of storage devices to store one or more additional copy of data stored in the plurality of storage devices.

16. A data storage device for providing high storage density, the storage device comprising:
a plurality of non-volatile memory chips; and
a memory controller coupled to the plurality of memory chips and configured to send and receive data traffic, wherein the plurality of the memory chips and the memory controller are integrated into a single chip, wherein the single chip is mounted on at least one side of a module board, wherein the data storage device sends and receives the data traffic over a data interface layer.

17. The storage device of claim 16, wherein the plurality of the memory chips are flash memory chips.

18. The storage device of claim 16, wherein the memory controller is a solid state drive (SSD) controller.

19. The storage device of claim 16, wherein the module board is a printed circuit board.

20. A method for providing dynamic allocation for application programs, the method comprising:
operating a data storage with at least one storage node comprising a node controller and a plurality of storage devices in communication with the node controller via a SAS expander interface, wherein the data storage presents to a client a single storage image for storing data, wherein the single storage image comprises a plurality of storage segments with reference addresses;
receiving a first data request of a first size;
allocating a first space from the single storage image at a reference address of available storage segment;
updating the reference address of available storage segment to reflect the allocation of the first space;
receiving a second data request of a second size;
allocating a second space from the single storage image at a updated reference address of available storage segment;
updating the reference address of available storage segment to reflect the allocation of the second space;
monitoring unused space in the first space and the second space;
using a pre-determined consolidation policy for determining whether a portion of the first space is to be freed;
if a portion of the first space is to be freed, re-allocating the second space to remove a unused portion of the first space; and
updating the reference address of available storage segment to reflect the re-allocation of the second space.

21. The method of claim 20, wherein method is performed on a pre-determined periodical frequency.
